(19) United States
(12) Patent Application Publication
(10) Pub. No.: US 2006/0257827 A1
(43) Pub. Date: Nov. 16, 2006

(54) Method and apparatus to individualize content in an augmentative and alternative communication device

(75) Inventor: Richard Ellenson, New York, NY (US)

Correspondence Address: GREENBERG-TRAURIG, 1750 TYSONS BOULEVARD, 12TH FLOOR, MCLEAN, VA, 22102, US

(73) Assignee: BlinkTwice, LLC, New York, NY (US)

(21) Appl. No.: 11/378,633

(22) Filed: Mar. 20, 2006

Related U.S. Application Data
(60) Provisional application No. 60/679,966, filed on May 12, 2005.

(51) Int. Cl. G09B 21/00

(52) U.S. Cl. 434/112

(57) ABSTRACT

An assistive communication apparatus which facilitates communication between a linguistically impaired user and others, wherein the apparatus comprises a display capable of presenting a plurality of graphical user interface elements; a camera which can record at least one image when operated by a user; at least one data storage device, the at least one data storage device capable of storing at least one image recorded from the camera, a plurality of auditory representations, and associations between at least one of the images recorded from the camera and at least one of the auditory representations; at least one processor which causes at least one image recorded from the camera which to be presented in the display.

### PRIORITY CLAIM AND CROSS-REFERENCE TO RELATED APPLICATION

The present invention is related to, and claims priority from, Provisional U.S. Patent Application Ser. No. 60/679,966 filed May 12, 2005, the contents of which are incorporated herein by reference in their entirety. This application relates to the subject matter of commonly owned U.S. Utility Application entitled “Language Interface and Apparatus Therefor” filed Jan. 4, 2006 by inventor Richard Ellenson, and assigned Ser. No. 11/324,777, the entire disclosure of which is incorporated herein by reference.

### FIELD OF THE INVENTION

The present invention relates to the field of portable linguistic devices, and more specifically provides an apparatus and methods through which a story can be told or with which the device's own content can be individualized and supplemented.

### BACKGROUND OF THE INVENTION

There are a variety of reasons why a person may be communicatively challenged. By way of example, without intending to limit the present invention, a person may have a medical condition that inhibits speech, or a person may not be familiar with a particular language.

Prior attempts at assisting communicatively challenged people have typically revolved around creating new structures through which complex communications, such as communications with a physician or other healthcare provider, or full, compound sentences, can be conveyed. For example, U.S. Pat. Nos. 5,317,671 and 4,661,916 to Baker et al., disclose a polysemic linguistic system that uses a keyboard from which the user selects a combination of entries to produce synthetic plural word messages, including a plurality of sentences. Through such a keyboard, a plurality of sentences can be generated as a function of each polysemic symbol in combination with other symbols which modify the theme of the sentence. Such a system requires extensive training, and the user must mentally translate the word, feeling, or concept they are trying to convey from their native language, such as English, into the polysemic language. The user's polysemic language entries are then translated back to English. Such “round-trip” language conversions are typically inefficient and are prone to poor translations.

Others, such as U.S. Pat. No. 5,169,342 to Steel et al., use an icon-based language-oriented system in which the user constructs phrases for communication by iteratively employing an appropriate cursor tool to interact with an access window and dragging a language-based icon from the access window to a phrase window. The system presents different icons based on syntactic and paradigmatic rules. To access paradigmatic alternative icons, the user must click and drag a box around a particular verb-associated icon. A list of paradigmatically-related, alternative icons is then presented to the user. Such interactions require physical dexterity, which may be lacking in some communicatively challenged individuals. Furthermore, the imposition of syntactic rules can make it more difficult for the user to convey a desired concept because such rules may require the addition of superfluous words or phrases to gain access to a desired word or phrase.

While many in the prior art have attempted to facilitate communication by creating new communication structures, others have approached the problem from different perspectives. For example, U.S. Patent Application Publication No. 2005/0089823 to Stillman, discloses a device for facilitating communication between a physician and a patient wherein at least one user points to pictograms on the device. Still others, such as U.S. Pat. No. 6,289,301 to Higginbotham, disclose the use of a subject-oriented phrase database which is searched based on the context of the communication. These systems, however, require extensive user interaction before a phrase can be generated. The time required to generate such a phrase can make it difficult for a communicatively challenged person to engage in a conversation.

Communicatively challenged persons are also frequently frustrated by the inability of current devices to quickly capture experiences and to be able to communicate these experiences to others. By way of example, a parent may take a picture of his or her child while on vacation using a digital camera. The parent can then use software running on a personal computer to record an explanation of the picture, such as the location and meaning behind the picture. The photograph and recording can then be transferred to current devices so that the child can show his or her friends the picture and have the explanation played for them. However, the recorded explanation is always presented in the parent's voice, and always with the same emphasis.

### SUMMARY OF THE INVENTION

Accordingly, the present invention is directed to apparatus and methods which facilitate communication by communicatively challenged persons which substantially obviate one or more of the problems due to limitations and disadvantages of the related art. As used herein, the term linguistic element is intended to include individual alphanumeric characters, words, phrases, and sentences.

In one embodiment the invention includes an assistive communication apparatus which facilitates communication between a linguistically impaired user and others, wherein the apparatus comprises a display capable of presenting a plurality of graphical user interface elements; a camera which can record at least one image when triggered by a user; at least one data storage device, the at least one data storage device capable of storing at least one image recorded from the camera, a plurality of auditory representations, and associations between the at least one image recorded from the camera and at least one of the plurality of auditory representations; at least one processor which causes at least one image recorded from the camera to be presented in the display.

In one embodiment of the invention includes a plurality of auditory representations stored in the at least one data storage device, the plurality of auditory representations also being stored on the at least one data storage device. Such an embodiment can also include an auditory output device, wherein the auditory output device is capable of outputting the auditory representations stored on the at least one data storage device.

In one embodiment of the invention includes a method for adapting a device, such as an assistive communication device. The method comprises receiving from a user an instruction to capture at least one image using a camera communicatively coupled to the device; receiving from the user at least one instruction to associate the captured at least one image with a user-actionable user interface element on the device; associating the user-actionable user interface element with an auditory representation stored on the device, wherein activation of the user-actionable user interface element triggers presentation of the associated auditory representation; and, displaying the associated at least one image as part of the user interface element.

In one embodiment of the invention is an assistive communication apparatus, comprising a data storage device, wherein at least one audio recording is stored on the data storage device; a processor, wherein the processor can utilize at least one of a set of algorithms to modify an audio recording to change perceived attributes of the recording; a display, wherein the display can allow a user to select from the at least one audio recordings stored on the data storage device and the set of algorithms, thereby causing the audio recording to be modified; and an audio output device, wherein the audio output device outputs the modified audio recording. By way of example, without intending to limit the present invention, the set of algorithms can include algorithms for changing the emotional expression of the audio recording, simulating shouting of the audio recording, simulating whispering of the audio recording, simulating whining of the audio recording, altering the perceived age of the speaker in the audio recording, and altering the perceived gender of the speaker in the audio recording. In one embodiment, the processor can apply the algorithms in real time, and in an alternative embodiment the algorithms are applied to the audio recording prior to a desired presentation time.

Additional features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings. It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of at least one embodiment of the invention.

In the drawings:

FIG. 1 is a schematic block diagram of a hardware architecture supporting the methods of the present invention.

FIG. 2 provides a front view of an embodiment of an apparatus on which the method of the present invention can be implemented.

FIG. 3 illustrates an embodiment of the apparatus of FIG. 2, wherein the apparatus is in picture taking mode.

FIG. 4 is a top view of an embodiment of the apparatus of FIG. 3, wherein the apparatus is in picture annotation mode.

FIG. 5 is a top view of an embodiment of the apparatus of FIG. 3, wherein the apparatus is determining whether a text message should be associated with the picture.

FIG. 6 is a top view of the embodiment of FIG. 5, wherein spelling has been activated to allow a text message to be entered.

FIG. 7 is a top view of the embodiment of FIG. 6, wherein individual letters can be selected.

FIG. 8 is a top view of the embodiment of FIG. 2, wherein a desired auditory representation filter can be selected.

FIG. 9 is a top view of the embodiment of FIG. 2, wherein a desired inflection can be selected.

FIG. 10 is a top view of the embodiment of FIG. 2, wherein the picture is stored as part of a story.

### DETAILED DESCRIPTION OF AN EMBODIMENT

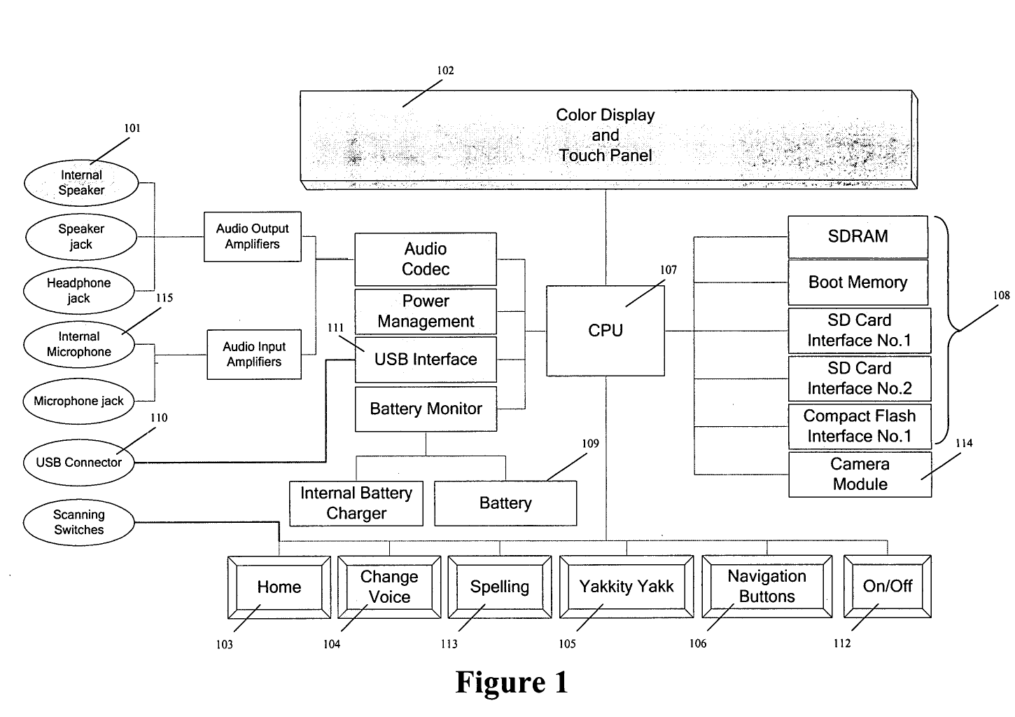

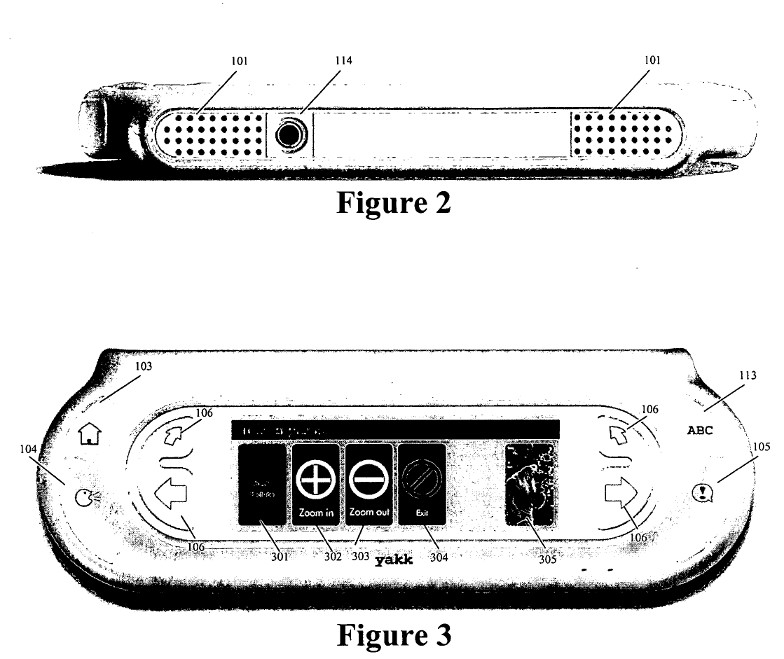

Reference will now be made in detail to various embodiments of methods and apparatus for individualizing content on an assistive communication device, and for creating and/or telling a story on a portable storytelling device, examples of which are illustrated in the accompanying drawings. While embodiments described herein are based on an implementation of the storytelling device as part of a specialized, portable computing device such as that illustrated in FIGS. 1 and 2, it should be apparent to one skilled in the art that the inventive methods and apparatus can also be implemented on any computing device, including, without limitation, a standard desktop computer, a laptop computer, a portable digital assistant (“PDA”), or the like. FIGS. 3-9 illustrate such embodiments. In FIGS. 3-5, the apparatus and the individual user interface elements are rendered on a computer display.

FIG. 1 is a schematic diagram of an embodiment of the invention as implemented on a portable computing device. The embodiment illustrated in FIG. 1 includes a central processing unit (“CPU”) 107, at least one data storage device 108, a display 102, and a speaker 101. An embodiment of the device may also include physical buttons, including, without limitation, home 103, voice change 104, Yakkity Yakk 105, navigation buttons 106, and power button 112.

As will be apparent to one skilled in the art, in the embodiment illustrated in FIG. 1, CPU 107 performs the majority of data processing and interface management for the device. By way of example, CPU 107 can load the stories and their related images and auditory representations (described below) as needed. CPU 107 can also generate information needed by display 102, and monitor buttons 103-106 for user input Where display 102 is a touch-sensitive display, CPU 107 can also receive input from the user via display 102.

In an embodiment, as illustrated in FIG. 1, the language interface is implemented as computer program product code which may be tailored to run under the Windows CE operating system published by Microsoft Corporation of Redmond, Wash. The operating system and related files can be stored in one of storage devices 108. Such storage devices may include, but are not limited to, hard disk drives, solid state storage media, optical storage media, or the like. Although a device that may be based on the Windows CE operating system is illustrated herein, it will be apparent to one skilled in the art that alternative operating systems, including, without limitation, DOS, Linux® (Linux is a registered trademark of Linus Torvalds), Apple Computer's Macintosh OSX, Windows, Windows XP Embedded, BeOS, the PALM operating system, or another or a custom-written operating system, can be substituted therefor without departing from the spirit or the scope of the invention.

In an embodiment, the device may include a Universal Serial Bus (“USB”) connector 110 and USB Interface 111 that allows CPU 107 to communicate with external devices. A CompactFlash, PCMCIA, or other adaptor may also be included to provide interfaces to external devices. Such external devices can allow user-selected auditory representations to be added to an E-mail, instant message (“IM”), or the like, allow CPU 107 to control the external devices, and allow CPU 107 to receive instructions or other communications from such external devices. Such external devices may include other computing devices, such as, without limitation, the user's desktop computer; peripheral devices, such as printers, scanners, or the like; wired and/or wireless communication devices, such as cellular telephones or IEEE 802.11-based devices; additional user interface devices, such as biofeedback sensors, eye position monitors, joysticks, keyboards, sensory stimulation devices (e.g., tactile and/or olfactory stimulators), or the like; external display adapters; or other external devices. Although USB and/or CompactFlash interfaces are advantageous in some embodiments, it should be apparent to one skilled in the art that alternative wired and/or wireless interfaces, including, without limitation, FireWire, serial, Bluetooth, and parallel interfaces, may be substituted therefor without departing from the spirit or the scope of the invention.

USB Connector 110 and USB Interface 111 can also allow the device to “synchronize” with a desktop computer. Such synchronization can include, but is not limited to, copying media elements such as photographs, sounds, videos, or multimedia files; and copying E-mail, schedule, task, and other such information to or from the device. The synchronization process also allows the data present in the device to be archived to a desktop computer or other computing device, and allows new versions of the user interface software, or other software, to be installed on the device.

In addition to receiving information via USB Connector 110 and USB interface 111, the device can also receive information via one or more removable memory devices that operate as part of storage devices 108. Such removable memory devices include, but are not limited to, Compact Flash cards, Memory Sticks, SD and/or XD cards, and MMC cards. The use of such removable memory devices allows the storage capabilities of the device to be easily enhanced, and provides an alternative method by which information may be transferred between the device and a user's desktop computer or other computing devices.

In an embodiment illustrated in FIG. 1, the auditory representations, pictures, interrelationships therebetween, and other aspects, of the apparatus which are described in more detail below, can be stored in storage devices 108. In an embodiment, the relationship between auditory representations and pictures may be stored in one or more databases, with auditory representations, pictures and other aspects stored in records and the interrelationships represented as links between records. By way of example, without intending to limit the present invention, such a database may contain a table of available auditory representations, a table of pictures, and a table of stories. Each picture, story, and auditory representation can be assigned a unique identifier for use within the database, thereby providing a layer of abstraction between the underlying picture information and the relational information stored in the database. Each table may also include a field for a word or phrase associated with each entry, wherein the word or phrase is displayed under the icon as the user interacts with the device.

In an embodiment, a browser-type model can be used wherein media elements are stored as individual files under the management of a file system. By way of example, but not by way of limitation, in such embodiment, other information can be represented in structured files, such as, but not limited to, those employing Standardized Generalized Markup Language (“SGML”), HyperText Markup Language (“HTML”), eXtensible Markup Language (“XML”), or other SGML-derived structures, RichText Format (“RTF”), Portable Document Format (“PDF”), or the like. Interrelationships between the media elements and the information can be represented in these files using links, such as Uniform Resource Locators (URLs) or other techniques as will be apparent to one skilled in the art. Similarly, relationships between the pictures which form stories may also be stored in one or more databases or browser based models in storage devices 108. By way of example, without intending to limit the present invention, such a web browser model may store the audio as data encoded using the Motion Picture Entertainment Group Level 3 (“MP3”), the Wave (“WAV”), or other such file formats; and image files as data encoded in the Portable Network Graphics (“PNG”), Graphics Interchange Format (“GIF”), Joint Photographic Experts Group (“JPEG”), or other such image file formats. Each linguistic element can be stored in a separate button file containing all of the data items that make up that linguistic element, including URLs for the corresponding audio and image files, and each group of linguistic elements can be represented in a separate page file that contains URLs of the to each of the linguistic element files in the group. The page files can also represent the interrelationships between individual linguistic elements by containing URLs of corresponding files for each linguistic element specified in the page file. Thus the full heirarchy of linguistic elements can be browsed by following the links in one page files to the other pages files, and following the links in a page file to the linguistic element files that are part of that group.

As will be discussed and illustrated in more detail below, the inventive method and apparatus provides a manner and means to customize and/or individualize contents extant in an assisted communication device. In an embodiment, the camera module 114 operates in a resolution and aspect ratio compatible with the display 102 of the device. In an embodiment, the display 102 provided comprises a touch panel, and is divided into a plurality of regions or buttons (not shown in FIG. 1); in such an embodiment, the camera module 114 may be adapted to operate in a resolution and aspect ratio corresponding, or substantially corresponding to, the resolution and aspect ratio of the buttons. The correspondence of the aspect ratio and the resolution between the camera module 114 and the display and touch panel 102 provides an integration that overcomes many of the steps required to change images on the device, including steps involving scaling and/or cropping. Moreover, the correspondence between these ratios and resolutions facilitates creation of images optimized for display quality and utilization, and for storage and processing efficiency. Display quality is facilitated through the use of images that are of identical resolution as the button (or other desired portion of the screen 102), thus scaling issues that may affect display quality are avoided. Display utilization is promoted by creating properly cropped images, permitting use of an entire button (or other desired portion of the display 102). Storage and processing efficiency is promoted because the images may be stored in a manner corresponding to the needed format (e.g., without limitation, as a jpeg or bitmap having the appropriate resolution, bit depth and aspect ratio); where the image is stored in the appropriate resolution no extra storage space is required for data that may be scaled away, and no additional processing is required to scale or otherwise needlessly process the image before display.

FIG. 2 provides a front view of an embodiment of the invention implemented as part of a portable device. As FIG. 2 illustrates, speakers 101 and camera 114 are provided on the front of the device.

By way of example, but not by way of limitation, an embodiment of the present invention permits users to capture pictures using a camera communicatively coupled to or integrated into the device and to store a description of events related to the picture or information relating to the subject matter of the picture. By way of example, without intending to limit the present invention, a linguistically challenged child may visit a zoo and observe a seal that splashes water at the child's parent. Although the child may not record a picture of the seal in the act of splashing the water, the child may take a picture of the seal after the fact, such that the seal serves as a trigger for the child's memory of the event. The child, the child's parent, a caregiver, or another person can then enter a text-based or verbal description of the events associated with the picture, such as “Daddy got soaked by this seal!”

Once a picture has been recorded by the camera, the user can enter a text-based caption which can optionally appear with the picture when the picture is displayed in the user interface. As described above, the user can also optionally enter a text-based description of the picture or events associated with the picture which can be used by a text-to-speech processor to tell a story associated with the picture. Where desirable, the user may optionally record a verbal description of the picture or events associated with the picture. For clarity, the term auditory representation as used herein refers to the text-based information and/or the verbal information corresponding to a picture. It should be apparent to one skilled in the art that although the entry of text and verbal information are described herein as separate processes, speech-to-text algorithms can be used to convert recorded verbal descriptions into text which can subsequently be used by the device for the same purposes as manually entered text-based information corresponding to the pictures.

In one embodiment, the user can build a story by associating a plurality of pictures and/or auditory representations. The plurality of pictures, or subsets thereof, can then be presented as user interface elements, such as a button, in the display. When the user activates a given user interface element, the auditory representation can be presented by the device. Such presentation may include, without limitation, the playback of an audio recording, the text-to-speech translation of the auditory representation, or the presentation of the text such as in an instant message or E-mail. Referring again to the zoo example described above, the parent or child may continue to take pictures of various animals seen around the zoo and to record information about the animals, such as funny things the animals did. The pictures can be combined into a story about the trip to the zoo, and all of the pictures, or a subset thereof, can be presented in the user interface to facilitate telling the story of the day at the zoo.

FIG. 3 illustrates an embodiment of the apparatus of FIG. 2. As an example, by not by way of limitation, FIG. 2 illustrates a screen 102 configuration for an inventive apparatus in picture taking mode. As FIG. 3 illustrates, the user can acquire the image as desired in image display 305 by pointing the camera lens 114 at the subject. Although FIG. 3 illustrates controls permitting the user to zoom in (302) and zoom out (303), it will be apparent to one skilled in the art that alternative controls can be added to the user interface, or substituted for those illustrated in FIG. 3, without departing from the spirit or the scope of the invention. For example, but not by way of limitation, controls can be provided for selection of a subject without physical movement of the entire apparatus. In one embodiment (not shown), the actual or apparent pan, swing and/or tilt of the lens can be operated by electronic controls, or by manual controls (not shown) such as a joystick. In an embodiment, once the user has aligned the image in image display 305, the take picture user interface element (301) may be engaged to acquire the image. In an embodiment, the user can press exit button 304 to leave picture taking mode without acquiring an image.

In one embodiment, the image displayed in image display 305 is the same aspect ratio as the graphical user interface element with which the image is or may become associated. This allows the user to easily ensure that the captured picture will fit the user interface element as desired without having to crop the picture or use other image manipulation software. Thus, in the embodiment illustrated in FIG. 3, since the user interface elements in the display are all a standard size, image display 305 is displayed as a substitute for a standard user interface element. In another embodiment, a plurality of aspect ratios may be used in the apparatus. By way of example, without intending to limit the present invention, the aspect ratio associated with a user interface element may change depending on display settings selected by the user, or by the functional mode in which the apparatus is operating. In such an embodiment, when the apparatus enters picture taking mode the apparatus may default to the aspect ratio associated with the most recently accessed or displayed user interface element, thus allowing the quickly take an appropriate picture without having to resize the picture to fit in an alternatively sized user interface element. Although the apparatus may pre-select the current aspect ratio for the photograph, in this embodiment the apparatus can also allow the user to select from the set of aspect ratios used by the device.

Although the above describes an embodiment regarding the acquiring of an image, it is within the scope of the present invention to permit selection of the display location before or after an image is acquired. Accordingly, using the inventive method, a user can acquire an image and then decide how to use the image, or where to locate the image in the device. This application is particularly suited for acquiring images that are party of a story, or for acquiring images that later become parts of a story. Similarly, however, using the inventive method, the user can select a location for the image before acquiring the image. This application is particularly suited for adding images to the non-story, hierarchical vocabulary of the device. In this latter case, a user may decide to add a picture of a food item, such as cranberry juice to the breakfast items already present in the assistive communication device. In an embodiment, by way of example, and not by way of limitation, the user may navigate to the breakfast items, select (or create) a location in which to acquire a new image, and then acquire the image. The image so acquired may be placed in a previously unused location, or can overwrite a previously stored image.

In one example a picture of juice could be replaced by a picture preferred by the user, without changing the auditory representation associated with the previously existing image. Similarly, it is within the scope of the invention (but not necessary) to permit replacement of an existing auditory representation without changing the image previously associated therewith, thereby permitting the image to become associated with a new auditory representation.

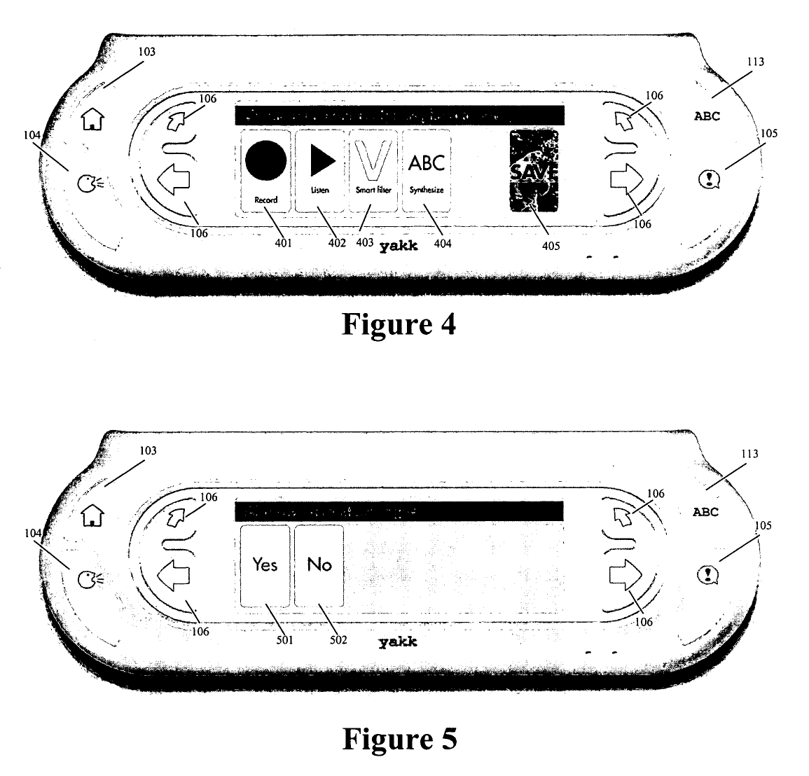

FIG. 4 is a top view of an embodiment of the apparatus of FIG. 3, wherein the apparatus is in picture annotation mode. Once an image has been captured, the user can associate the image with an auditory representation. Such an association may be based on auditory representations previously stored in the apparatus, or based on new auditory representations as entered through an interface such as that illustrated in FIG. 4.

As described above, the present invention is for use by communicatively challenged persons. Thus, although the user may operate the interface of FIG. 4 to record or type the auditory representations by himself or herself, it is anticipated that another person may record or type the auditory representation instead. By way of example, without intending to limit the present invention, a tourist who does not speak the native language of a country they are visiting may take a picture of the street signs at the intersection of A and B streets near his or her hotel. Upon activation of record button 401, the apparatus can accept the hotel's doorman, a front desk clerk, or another person as they speak or type the phrase “please direct me to the intersection of A and B streets” in the native language of that country. In an embodiment, the auditory representation can then be accessed by pressing or otherwise interacting with listen button 402. Once an acceptable auditory representation has been stored by the apparatus, it can then be presented to a taxi driver, police officer, or others should the user, for example, become in need of directions to his or her hotel. If an auditory representation and/or image are no longer needed, either or both may be deleted from the apparatus.

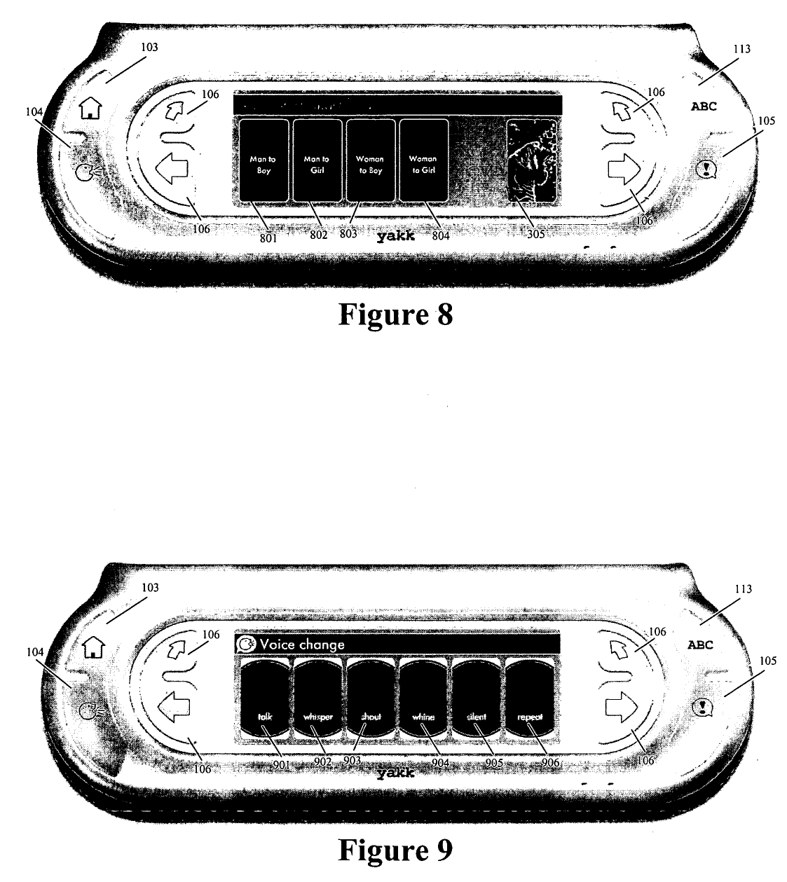

In an embodiment, a parent or caretaker of a communicatively challenged individual may take a picture of a bottle of pomegranate juice and/or provide the auditory representation of the sentence “I'd like some pomegranate juice, please.” The challenged individual can then simply activate a user interface element containing the picture of the pomegranate juice bottle to cause the device to, for example, play back the appropriate auditory representation.

Where, for example, the communicatively challenged individual is a child, the child may wish to have the “voice” of an auditory representation altered so that the child appears to speak with a more appropriate voice, for example, without limitation, closer to their own. Similarly, a communicatively challenged male with a female caretaker recording the auditory representations may desire to alter the recorded voice to more closely approximate a male voice. Accordingly, in an embodiment of the invention, the voice can be altered by use of filter or other means by accessing a filter button 403 on the user interface. In an embodiment, accessing the filter button 403 may present an interface similar to that of FIG. 8 and/or FIG. 9. In an embodiment, a specific filter can be predefined, and pressing the filter button 403 simply applies the predefined filter to the auditory representation. As used herein the expression filter is used in the broadest sense of the word, and is simply used to represent a process or device that will cause an auditory representation to be altered. The filter may affect the pitch and/or tempo of the auditory representation, and/or may enhance, deemphasize and/or remove various frequencies in the auditory representation.

The interface illustrated in FIG. 8 allows a user to change the apparent gender and/or age of the speaker in an auditory representation by selecting one of user interface elements 801-804. (It is within the scope of the present invention, however, to use a filter or set of filters to make any type of audible change to the audible representation. Thus, for example, in an embodiment, the filter consists of parameters for a text-to-speech engine present in the device.) As discussed above, alteration of the auditory representation can allow the customization and/or individualization of the auditory representation reproduced by the device. By way of example, without intending to limit the present invention, software such as AV Voice Changer Software Diamond, distributed by Avnex, LTD of Nicosia, Cyprus may be utilized to change the tonal characteristics of the auditory representation, including the perceived age and/or gender of the speaker and the inflection or emotion of the recorded speech, such as by modifying the pitch, tempo, rate, equalization, and reverberation of the auditory representation.

It will be apparent to one of skill in the art that changes in the auditory representation may be made at the time the auditory representation is first saved, or thereafter. Moreover, it will be apparent to one of skill in the art that the alteration itself may be made, for example, directly to the recorded sound, and the altered sound stored on the device. This reduces the processing required at playback time. Alternatively, or additionally, the alteration may be made at playback time by storing, and later, e.g., at playback, providing parameters to the filtering system. Storing the desired changes and associating them with the auditory representation later, or in real time, permits the ready reversal or removal of the changes, even where the changes would represent a non-invertible transformation of the sound. In addition, as will be apparent to one of skill in the art, this later arrangement may allow more consistent application of the alteration algorithms (which could, e.g., change from time to time), thereby providing a more consistent voice across multiple auditory representations.

Turning to FIG. 9, a voice change menu 901-906 is presented. In an embodiment, this menu 901-906 is available to the user at or near playback time to permit context sensitive changes in voice; the menu 901-906 may additionally, or alternatively, be available at or near recording time or at any intermediate time that a user selects to change an auditory representation. In an embodiment, the menu is displayed in response to accessing voice change key 104, and operates to change the voice of the next auditory representation as selected by the user. The interface illustrated in FIG. 9 allows the user to select one of user interface elements 901-906 to alter the inflection associated with the auditory component. As discussed above in connection with FIG. 8, such alterations can be used to filter the auditory representation, which can then be stored or played. In an embodiment, the voice change alteration may be used to create a temporary state for the system, staying in effect until changed, exited or timed out. In an embodiment, the voice change alteration may remain in effect only for the next auditory representation. In an embodiment, the voice change alteration may be used in a variety of ways, such as, for example, by pressing it once to permit use with a single auditory representation, and twice to make it stateful.

As depicted in FIG. 9, the voice change menu 901-906 permits exemplary changes to the apparent voice as talk 901, whisper 902, shout 903, whine 904, silent 905 and respect 906. As will be apparent to one of skill in the art, the entire range and subtlety of human speech and emotion expressed in speech may be used. Moreover, the interface can be configured to use directional keys 106 to access further voice changes.

While the changes to the auditory representations set forth above are described generally from the perspective of altering sound recordings, it should be apparent to one skilled in the art that similar algorithms can be applied to simulated speech such as that generated through a text-to-speech algorithm.

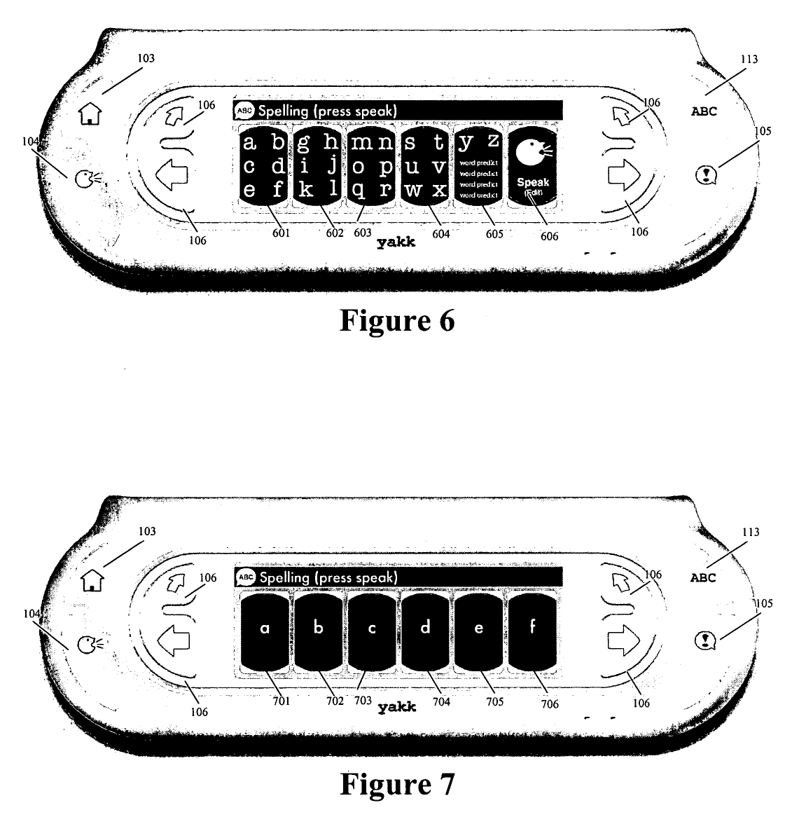

In addition to recording sounds and making changes thereto, an embodiment of the present invention also allows the user to create text-based auditory representations to be associated with the picture. In FIG. 5, the user can elect whether or not to create such a text-based auditory representation by selecting one of user interface elements 501 and 502. If the user elects to create the text-based auditory representation, the text can be entered through a keyboard arrangement similar to that illustrated in FIGS. 6 and 7. In FIG. 6, the user selects from sets of letters (user interface elements 601-605) that set which contains a desired letter. The display then changes to one similar to FIG. 7, wherein individual letters (user interface elements 701-706) are presented such that the user can select the desired letter. In one embodiment, once the user selects a letter from the interface of FIG. 7, the user is returned to the interface of FIG. 6 to continue selecting letters. By pressing speak button 606, the user can cause the apparatus to generate a text-to-speech version of the currently entered text.

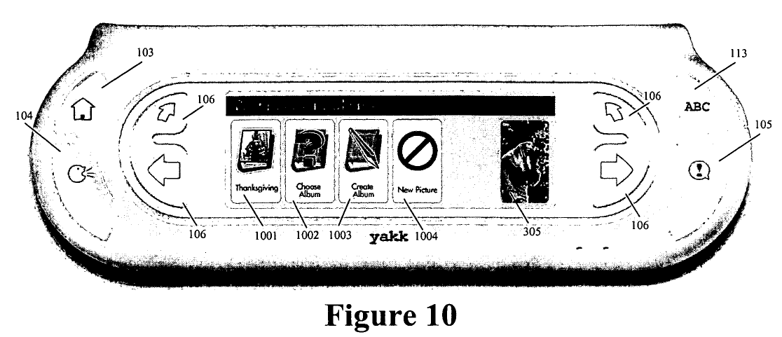

As described above, a picture and its associated auditory representation can be combined with other pictures to create a story or to replace or augment the vocabulary of the language heirarchy. FIG. 10 illustrates a user interface through which a story can be created. User interface element 1001 represents the story to which a picture has been most recently added. By selecting this user interface element, the user is presented with at least a subset of the pictures associated with that story, and the user can determine the appropriate location or order for the new picture. User interface element 1002 allows the user to select from additional, previously existing stories. User interface element 1003 allows the user to create a new story with which the picture is to be associated. User interface element 1004 allows the user to discard the current picture and take a new picture. Although described above in terms of stories, it should be apparent to one skilled in the art that alternative picture collections, including, without limitation, scrapbook pages, picture albums, and the like, may be substituted therefor without departing from the spirit or the scope of the invention. Furthermore, although the stories are described as collections of pictures, it should be apparent to one skilled in the art that because each photograph can have at least one auditory representation associated therewith, the stories also can be seen as collections of auditory representations, and permitting the user to build a story based on auditory representations may be substituted for the above-described picture-based story creation method without departing from the spirit or the scope of the invention.

In an embodiment, the camera of the inventive device captures an image on a CCD. Because the CCD has substantially higher resolution than the display, prior to acquiring an image, in an embodiment, the camera may be panned and/or zoomed electronically. An image may be acquired by storing all of the pixels in a rectangle of the CCD defined by the pan and/or zoom settings and the aspect ratio for the display. In an embodiment, the stored image includes all of the pixels from the rectangle at the full resolution of the CCD. In an embodiment, the stored image includes the pixels at the resolution of the display. In an embodiment, the image is stored in one manner for display (e.g., the pixels at the resolution of the display), and in one manner for printing or other applications (e.g., all of the pixels from the rectangle at the full resolution of the CCD). In an embodiment, the all of the pixels from the CCD are stored, along with an indication of the size and location of the rectangle when the image was acquired.

In an embodiment of an assisted communication device, images used as part of a photo album are stored in two resolutions, one for display on the device and in another for printing or other applications, while images used as part of the user interface are stored only in one resolution (e.g., display resolution).

In an embodiment, the inventive device is able to be used to create a story from auditory elements in addition to images. In an embodiment, a story name is provided by a user, and then a plurality of content elements in the form of auditory or other sound recordings or text. The content elements may be entered in order, or may thereafter be ordered into the order that they will be used in a story. In an embodiment the content elements may be, but need not be, associated with existing images on the device, which can simply be numerals indicating the order in which they were recorded or are to be played, or can be other images. In an embodiment, once all such recordings or text have been entered, a manner of altering the voice of the story can be selected, and can be applied to all content elements associated with the story.

While the invention has been described in detail and with reference to specific embodiments thereof, it will be apparent to those skilled in the art that various changes and modifications can be made therein without departing from the spirit and scope thereof. Thus, it is intended that the present invention cover the modifications and variations of this invention provided they come within the scope of the appended claims and their equivalents.

What is claimed is:

1. A method for communicating using a communication device, the method comprising the steps of:
selecting a display location for an image, the display location being associated with a specific resolution and a specific aspect ratio;
acquiring the image in the specific resolution and the specific aspect ratio;
acquiring an auditory representation related to the image;
associating the image with the auditory representation;
defining an alteration for the auditory representation; and
accessing the image in the display location thereby causing output of an altered auditory representation.

2. The method of claim 1 wherein the step of selecting is performed prior to the step of acquiring the image.

3. The method of claim 2 wherein the image includes a pictorial representation of a lingual element for use in the communication device, and the auditory representation comprises an auditory representation of the lingual element.

4. The method of claim 3 wherein the display location is a location within a lingual communication hierarchy.

5. The method of claim 1 wherein the step of selecting is performed subsequent to the step of acquiring the image.

6. The method of claim 1, further comprising the steps of:
selecting a second display location for a second image, the second display location being associated with the specific resolution and the specific aspect ratio;
acquiring the second image in the specific resolution and the specific aspect ratio;
acquiring a second auditory representation related to the second image;
associating the second image with the second auditory representation;
defining a second alteration for the second auditory representation; and
accessing the second image in the second display location thereby causing output of a second altered auditory representation.

7. The method of claim 6 wherein the second alteration is the same as the first alteration.

8. The method of claim 7 wherein the first display location and the second display locations are associated with a story.

9. An assistive communication apparatus, the apparatus facilitating communication between a communicatively challenged user and others, comprising:
a display, wherein the display is capable of presenting a plurality of graphical user interface elements;
a camera, wherein the camera records at least one image when triggered by a user;
at least one data storage device, wherein the at least one data storage device stores at least one image recorded from the camera and a plurality of auditory representations, and wherein the data storage device further stores associations between the at least one image recorded from the camera and at least one of the plurality of auditory representations;
at least one processor, for displaying as a graphical user interface element in the display the at least one image recorded from the camera.

10. The apparatus of claim 9, further comprising:
an auditory output device, wherein the auditory output device is capable of outputting the auditory representations stored on the at least one data storage device.

11. The apparatus of claim 10, wherein the audio output device is a speaker.

12. The apparatus of claim 10, wherein the audio output device is a headset jack.

13. The apparatus of claim 10, wherein the audio output device is an external device interface.

14. The apparatus of claim 13, wherein the external device interface allows the audio output device to output the auditory representations of linguistic elements as text.

15. The apparatus of claim 13, wherein at least a portion of the text is output in an instant message.

16. The apparatus of claim 13, wherein at least a portion of the text is output in an E-mail.

17. The apparatus of claim 9, wherein the camera is communicatively coupled to the apparatus.

18. The apparatus of claim 9, wherein at least one of the plurality of auditory representations includes recorded speech.

19. The apparatus of claim 18, wherein the at least one processor allows the user to modify tonal characteristics of the recorded speech.

20. The method of claim 19, wherein the tonal modifications include at least one of the pitch, tempo, rate, equalization, and reverberation of the recorded speech.

21. The method of claim 19, wherein the tonal modifications include modifying the perceived gender of the speaker.

22. The method of claim 19, wherein the tonal modifications include modifying the perceived age of the speaker.

23. The apparatus of claim 9, wherein the at least one processor allows the user to associate a plurality of the at least one recorded images to create a story.

24. The apparatus of claim 23, wherein the display presents the story as a plurality of concurrently presented images

25. The apparatus of claim 24, wherein the display allows the user to select at least one of the concurrently presented images, and wherein the processor causes the at least one auditory representation associated with the selected at least one of the concurrently presented images to be played back.

26. The apparatus of claim 23, wherein each image captured by the camera is stored in a default photo album unless an alternative photo album is chosen by the user.

27. The apparatus of claim 26, wherein each subsequent image captured by the camera is stored by default in the same photo album as the previous image unless an alternative photo album is chosen by the user.

28. The apparatus of claim 9, further comprising a microphone, wherein the microphone records speech when triggered by the at least one user.

29. The apparatus of claim 28, wherein the speech is stored on the data storage device such that the at least one sound functions as an auditory representation.

30. The apparatus of claim 9, wherein the at least one image recorded by the camera is the appropriate aspect ratio for the user interface element in which the picture will be displayed.

31. The apparatus of claim 30, wherein all user interface elements utilize the same aspect ratio.

32. A method for adapting a device, comprising:
receiving from a user an instruction to capture at least one image using a camera communicatively coupled to the device;
receiving from the user at least one instruction to associate the captured at least one image with a user-actionable user interface element on the device;
associating the user-actionable user interface element with an auditory representation stored on the device, wherein activation of the user-actionable user interface element triggers presentation of the associated auditory representation; and,
displaying the associated at least one image as part of the user interface element.

33. The method of claim 32, wherein the user-actionable user interface element is a button.

34. The method of claim 32, further comprising playing the associated recording when the user-actionable user interface element is triggered by the user.

35. The method of claim 32, further comprising receiving from the user at least one instruction to associate a plurality of the captured images with a story.

36. The method of claim 35, further comprising displaying at least part of the story as a plurality of images selected from the plurality of the captured images associated with the story.

37. The method of claim 36, wherein selection of one of the displayed images causes all of the at least one sounds associated with the story to be sequentially played.

38. The method of claim 32, further comprising receiving from the user at least one instruction to associate a plurality of the captured images with a set of instructions.

39. The method of claim 32, further comprising receiving from the user at least one instruction to associate a plurality of the captured images with a photo album.

40. The method of claim 32, wherein the auditory representation is a recording.

41. The method of claim 32, wherein the auditory representation is stored as information representative of the auditory representation.

42. The method of claim 41, wherein the information representative of the auditory representation is text.

43. The method of claim 42, further comprising outputting the text via a text to speech algorithm.

44. The method of claim 42, further comprising outputting the text as at least a portion of an instant message.

45. The method of claim 42, further comprising outputting the text as at least a portion of an E-mail.

46. The method of claim 32, further comprising allowing a user to modify the tonal characteristics of an auditory representation stored on the device.

47. The method of claim 46, wherein the tonal modifications include at least one of the pitch, tempo, rate, equalization, and reverberation of the auditory representation.

48. The method of claim 46, wherein the tonal modifications include modifying the perceived age of a speaker of the auditory representation.

49. The method of claim 46, wherein the tonal modifications include modifying the perceived gender of a speaker of the auditory representation.

50. The method of claim 32, wherein the aspect ratio of the captured at least one image is equal to that of a standard user interface element for the device.

51. The method of claim 32, wherein the aspect ratio of the captured at least one image is equal to that of the user interface element in which the image is to be displayed.

52. An assistive communication apparatus, comprising:
a data storage device, wherein at least one audio recording is stored on the data storage device;
a processor, wherein the processor can utilize at least one of a set of algorithms to modify an audio recording to change perceived attributes of the recording;
a display, wherein the display can allow a user to select from the at least one audio recordings stored on the data storage device and the set of algorithms, thereby causing the audio recording to be modified; and
an audio output device, wherein the audio output device outputs the modified audio recording.

53. The assistive communication apparatus of claim 52, wherein the set of algorithms includes an algorithm for changing the emotional expression of the audio recording.

54. The assistive communication apparatus of claim 52, wherein the set of algorithms includes an algorithm for simulating shouting of the audio recording.

55. The assistive communication apparatus of claim 52, wherein the set of algorithms includes an algorithm for simulating whispering of the audio recording.

56. The assistive communication apparatus of claim 52, wherein the set of algorithms includes an algorithm for simulating whining of the audio recording.

57. The assistive communication apparatus of claim 52, wherein the set of algorithms includes an algorithm for altering the perceived age of the speaker in the audio recording.

58. The assistive communication apparatus of claim 52, wherein the set of algorithms includes an algorithm for altering the perceived gender of the speaker in the audio recording.

59. The assistive communication apparatus of claim 52, wherein the processor can apply the algorithms in real time.

60. The assistive communication apparatus of claim 52, wherein the algorithms are applied to the audio recording prior to a desired presentation time.

61. A method for adding content to a communication device, the method comprising the steps of:
selecting a display location for an image, the display location being associated with a specific resolution and a specific aspect ratio;
acquiring the image in the specific resolution and the specific aspect ratio;
acquiring an auditory representation related to the image;
associating the image with the auditory representation;
defining an alteration for the auditory representation; and
associating the alteration with the auditory representation in a manner that will cause an output of the auditory representation to be altered.

62. A method for telling a story to a recipient using a communication device, the method comprising the steps of:
selecting a location for a first content element;
acquiring the first content element;
selecting a location for a second content element;
acquiring the second content element;
selecting a location for a third content element;
acquiring the third content element;
associating each of the first, second and third content elements with a first, second and third user interface element, respectively; and
accessing the first, second and third user interface elements in sequence;
wherein the accessing of a user interface element causes the content element to be conveyed to the recipient.

63. The method of claim 62, further comprising the steps of:
defining an alteration for an auditory representation; and
associating the alteration with the content elements in a manner that will cause an output of the content elements to be altered.

64. The method of claim 63, wherein the alteration defined is an alteration from an adult voice to a child voice.
